(19) United States
(12) Patent Application Publication
(10) Pub. No.: US 2005/0207441 A1
(43) Pub. Date: Sep. 22, 2005

(54) Packet transmission scheduling in a multi-carrier communications system

(76) Inventors: Eko N. Onggosanusi, Allen, TX (US); Anand G. Dabak, Plano, TX (US); Timothy M. Schmidl, Dallas, TX (US); Aris Papasakellariou, Dallas, TX (US); Jalganesh Balakrishnan, Bangalore (IN); Yan Hui, San Diego, CA (US)

Correspondence Address: TEXAS INSTRUMENTS INCORPORATED, P O BOX 655474, M/S 3999, DALLAS, TX, 75265, US

(21) Appl. No.: 11/085,452

(22) Filed: Mar. 21, 2005

Related U.S. Application Data
(60) Provisional application No. 60/555,729, filed on Mar. 22, 2004.

(51) Int. Cl. H04J 15/00

(52) U.S. Cl. 370/464

(57) ABSTRACT

Method for packet transmission scheduling in a multi-carrier communications system. A preferred embodiment comprises selecting a set of users from a group of users who are targets of intended transmissions, wherein the selection is based upon channel quality information, determining a set of transmission parameters for each user in the set of users, and scheduling transmissions to the set of users. The channel quality information, which can be provided by the users of the multi-carrier communications system, can permit the exploitation of frequency diversity inherent in the multi-carrier communications system to increase system capacity to beyond a simple sum of carrier transmission bandwidth.

This application claims the benefit of U.S. provisional application Ser. No. 60/555,729, filed Mar. 22, 2004, entitled “Packet Scheduling and Adaptive Modulation-Coding for 3xEV-DV” which application is hereby incorporated by reference.

### TECHNICAL FIELD

The present invention relates generally to a method for digital communications, and more particularly to a method for scheduling packet transmissions in a multi-carrier communications system.

### BACKGROUND

In a communications system, the scheduling of transmissions (or packets that make up the transmissions) is an important task that can have a large impact on the overall performance of the communications system. If scheduling is not done properly, with consideration given to available network bandwidth, network quality, user priority, fairness, and so forth, it is possible to prevent users with low priority from having access to the communications system, have users with huge transmissions consume a vast majority of available network bandwidth, saturate the network so that few (or no) transmissions successfully complete, and so on. In a multi-carrier communications system, where there are a large number of carriers over which transmissions can take place, packet scheduling can even be more vital to ensuring good overall network performance.

The plurality of carriers in a multi-carrier communications system can permit a good packet scheduling mechanism to exploit frequency diversity to increase system capacity until it is greater than a total bandwidth of the carriers. The total bandwidth of the carriers is simply the number of carriers multiplied by the bandwidth of each carrier, assuming that each carrier has the same bandwidth. If different carriers have different bandwidth, then the total bandwidth is a sum of the individual carrier bandwidths. By increasing the system capacity of the multi-carrier communications system to greater than the total bandwidth of the carriers, more information can be transmitted in less time with fewer errors.

A technique that has been used in multi-carrier communications systems to schedule packet transmissions is to simply schedule a packet transmission onto a carrier(s) when there is adequate carrier bandwidth to complete the transmission. This simple technique permits the scheduling of packet transmissions without requiring significant processing power to perform scheduling tasks as well as little control information feedback to reduce network overhead in the multi-carrier communications system.

One disadvantage of the prior art is that by simply scheduling packet transmissions based on available carrier bandwidth, the overall system capacity of the multi-carrier communications system does not exceed the total bandwidth of the individual carriers. In other words, frequency diversity is not exploited to increase system capacity to a level that is greater than the total bandwidth of the individual carriers.

### SUMMARY OF THE INVENTION

These and other problems are generally solved or circumvented, and technical advantages are generally achieved, by preferred embodiments of the present invention which provides a system and method for exploiting diversity in a multi-carrier communications system to improve retransmission performance.

In accordance with a preferred embodiment of the present invention, a method for scheduling transmissions in a multi-carrier communications system is provided. The method comprises selecting a set of users from a group of users that are targets of intended transmissions, wherein the selection is based on channel quality information, determining a set of transmission parameters for each user in the set of users, and scheduling transmissions to the set of users.

In accordance with another preferred embodiment of the present invention, a method for scheduling transmissions in a multi-carrier communications system is provided. The method comprises transmitting a transmission to active users in the multi-carrier communications system, wherein the transmission occurs over a plurality of carriers, wherein the active users comprise every user in the multi-carrier communications system, receiving channel quality information from each active user, and scheduling future transmissions to a user using the channel quality information provided by the active users.

An advantage of a preferred embodiment of the present invention is that by exploiting frequency diversity and intelligent packet scheduling, the system capacity can be increased to more than the sum of the bandwidths of the individual carriers.

A further advantage of a preferred embodiment of the present invention is that the use of channel quality information can permit the assignment of various transmission parameters to optimize a transmission based upon the quality of the carrier(s) used to carry the transmission. For example, in a carrier with low quality, error correction can be increased, transmission bandwidth can be reduced, and so forth to help increase the probability of successful transmission.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a frequency band diagram of a frequency allocation of carriers in a multi-carrier communications system;

FIG. 2 is a diagram of a pair of electronic devices communicating over a plurality of carriers;

FIG. 3 is a diagram of an algorithm for use in scheduling a transmission at a transmitter of a multi-carrier communications system, according to a preferred embodiment of the present invention;

FIG. 4 is a diagram of an algorithm for use in scheduling transmissions in a multi-carrier communications system, wherein channel quality indicators (CQI) are available for each carrier associated with a UE, according to a preferred embodiment of the present invention;

FIG. 5 is a diagram of an algorithm for use in scheduling transmissions in a multi-carrier communications system, wherein a CQI is representative of all carriers associated with a UE, according to a preferred embodiment of the present invention; and

FIG. 6 is a diagram of a portion of a BS of a multi-carrier communications system, wherein the BS makes use of CQI to schedule and determine modulation-coding schemes for transmissions from the BS, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a three-carrier multi-carrier communications system, such as 3xEV-DV, which is an extension to a single carrier communications system 1xEV-DV. 1xEV-DV is an evolution of CDMA2000 and supports voice and high-speed data using code-division multiple access (CDMA). The invention may also be applied, however, to multi-carrier communications systems in general, with no limit on the number of carriers, such as NxEV-DV (an N-carrier EV-DV system) and an extension to 1xEV-DO, which is yet another evolution of CDMA2000, which can be termed NxEV-DO system. Furthermore, each carrier in the multi-carrier communications system may use different modulation techniques or they may all use a single modulation technique. For example, an exemplary multi-carrier communications system may have a single carrier using CDMA modulation and remaining carriers using any combination of CDMA and orthogonal frequency division multiplexing (OFDM). In addition to using different modulations, the carriers in an exemplary multi-carrier communications system may make use of different modulation parameters, such as different spreading codes, numbers of tones, and so forth, as well as different modulations.

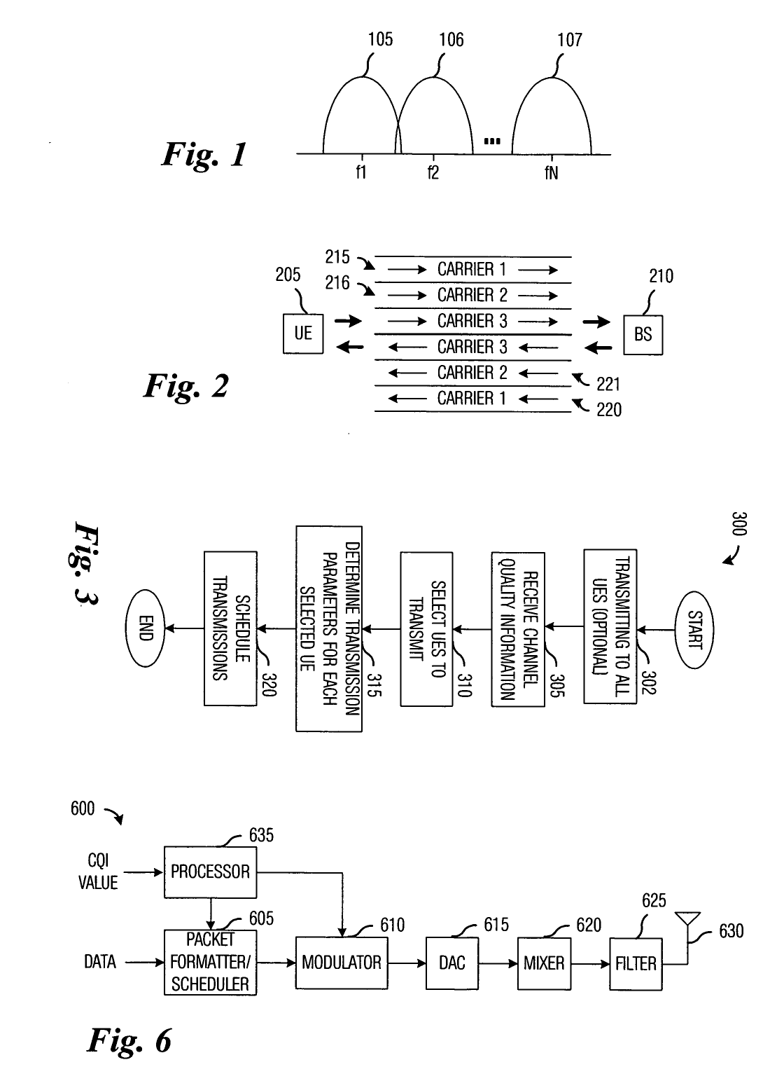

With reference now to FIG. 1, there is shown a frequency band diagram illustrating a frequency allocation of carriers in an exemplary multi-carrier communications system. The exemplary multi-carrier communications system, as shown in FIG. 1, has N carriers, wherein N is an integer number. Each carrier in the exemplary multi-carrier communications system, such as carrier #1 105, carrier #2 106, and carrier #N 107, can span a particular frequency range. Each frequency band can have a center frequency, frequency f1 for carrier #1 105, for example, as well as a certain bandwidth. Each band can have a different bandwidth, the same bandwidth, or combinations thereof. Advantages arising from using multiple carriers rather than a single carrier can include compatibility with legacy systems, the use of different data transmission schemes and modulation schemes in different carriers, the ability to skip certain portions of the spectrum that may already be in use, and so forth. Note that the term carrier can be used interchangeably with the term channel.

With reference now to FIG. 2, there is shown a diagram illustrating a pair of electronic devices communicating over a plurality of carriers. As shown in FIG. 2, the pair of electronic devices comprises user equipment (UE) 205 and a base station (BS) 210. However, it can be possible for UE 205 to communicate directly with other UE 205 or for one BS 210 to communicate with another BS 210. When the UE 205 is transmitting to the BS 210, it has several carriers at its disposal, including carrier #1 215 and carrier #2 216. Note that within a single carrier, such as carrier #1 215, there may exist multiple channels. When the BS 210 is transmitting to the UE 205, it can also transmit over a plurality of carriers, such as carrier #1 220 and carrier #2 221.

When an electronic device, such as the UE 205, has data to transmit, the selection of which carrier(s) to use can be dependent upon factors such as carrier and channel quality indicators, current communications network load, data priority, quality of service requirements, and so forth. The carrier selection, transmission prioritization, scheduling, and so on can be made at a transmitter of the electronic device.

With reference now to FIG. 3, there is shown a diagram illustrating an algorithm 300 for use in scheduling a transmission at a transmitter of a multi-carrier communications system, according to a preferred embodiment of the present invention. The algorithm 300 provides a high-level view of transmission scheduling in a multi-carrier communications system to help increase the overall network throughput. In order to achieve good transmission scheduling results, a transmitter needs to have good information regarding carriers that are available for use in the multi-carrier communications system. Since a wireless environment can be continually changing, good information usually means up-to-date information. Information about the carriers can be in the form of channel quality indicators, which can be numerical values representative of the channel bandwidth of a carrier. A channel quality indicator (CQI) can represent a single carrier or a plurality of carriers. For a detailed discussion of channel quality indicators, their computation, and their use, refer to a co-assigned, co-pending patent application entitled “Method for Channel Quality Indicator Computation and Feedback in a Multi-Carrier Communications System,” attorney docket number TI-38146, which application is hereby incorporated by reference.

Optionally, if the transmitter does not have up-to-date channel quality information, the transmitter may be able to initiate an update of the channel quality information by transmitting to UEs in the multi-carrier communications network (block 302). Note that in this context, the terms UE and user can be used interchangeably. The transmission may be a normal data transmission, a control transmission, a special transmission intended to initiate an update of the channel quality information, or it may be an automatic transmission on a designated feedback channel. The transmission may be made to active UEs in the multi-carrier communications system, wherein active UEs are all UEs that are currently registered with the multi-carrier communications system. Alternatively, for a multi-carrier communications system that makes use of time division duplexing (TDD), updates of the CQI can be obtained by exploiting reciprocity of downlink and uplink channels via a measurement of the uplink channels. If the transmitter already possesses up-to-date channel quality information or has just recently received a transmission updating its channel quality information (block 305), then the self initiated update of the channel quality information (block 302) may not be necessary. Using this channel quality information, the transmitter can select a number of UEs for which it will schedule transmissions (block 310). The UEs may be selected from a group of UEs made up of UEs which have transmissions intended for them. Therefore, the transmitter will not select a UE which does not have a transmission intended for it. Note that if the bandwidth requirements are less than the available bandwidth, then the transmitter may simply select all UEs with transmissions. However, if the needed bandwidth exceeds the demand, then the transmitter may select UEs based upon factors such as priority, connection priority, quality of service requirements, time since last service, size of transmission, size of transmission remaining, time of transmission initiation, and so on. The UEs not selected can be placed in a waiting list for selection at a next transmission scheduling.

The transmitter can then assign carriers to the different UEs. In addition to assigning carriers to UEs, the transmitter can make decisions on modulation and transmission parameters for each of the UEs (block 315). For example, if a UE requires a highly reliable transmission of a small amount of information, the transmitter may elect to increase the amount of error correcting data included in the UE's transmission to help increase the probability of a successful transmission. However, if a UE requires a low latency transmission with a high tolerance for errors, such as with streaming video, then the transmitter may elect to provide a minimal level of error correcting data and assign the transmission to take place on a carrier (or carriers) with large bandwidth. Once the transmitter completes making transmission parameter selections, the transmitter can actually schedule the transmissions (block 320). The scheduling of the transmissions may include the specification of a time for injecting the transmissions into the multi-carrier communications network, the insertion of data for the transmissions into transmission buffers, and so forth. With the transmissions scheduled, the transmitter can perform the transmissions and then finish if there are no additional UEs to schedule or return to block 305 if there are additional UEs to schedule.

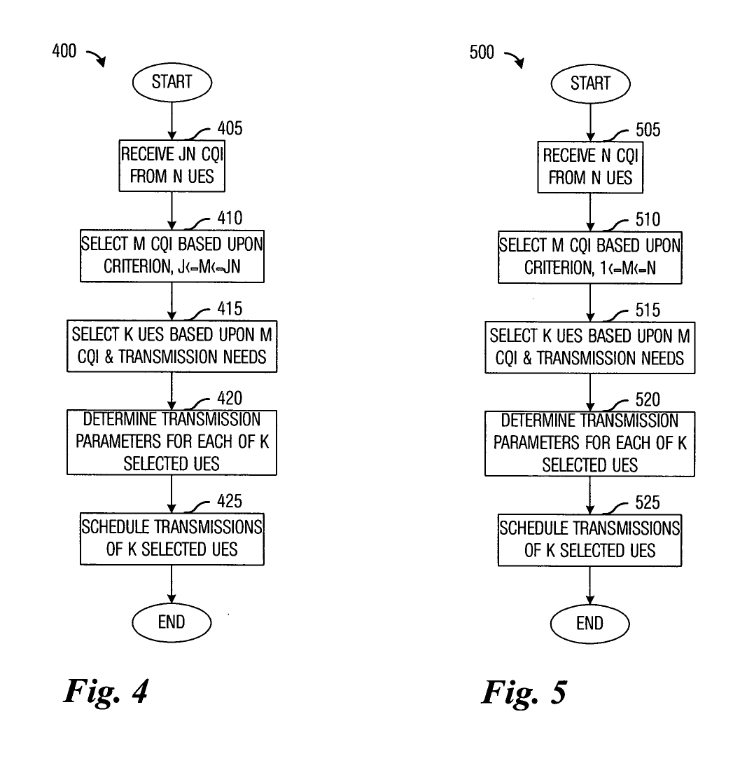

With reference now to FIG. 4, there is shown a diagram illustrating an algorithm 400 for use in scheduling transmissions in a multi-carrier communications system, wherein channel quality indicators (CQI) are available for each carrier associated with each UE, according to a preferred embodiment of the present invention. The algorithm 300 (FIG. 3) provided a high-level view of a technique for scheduling transmissions using CQIs, the algorithm 400 provides a detailed view of an implementation of such a technique, wherein CQIs for each carrier associated with active UEs in a multi-carrier communications system are used in the scheduling of transmissions.

As with the algorithm 300, the algorithm 400 makes use of up-to-date CQIs in its transmission scheduling. Therefore, a transmitter performing the transmission scheduling requires CQIs that are recent, such as ones just received from the UEs. According to a preferred embodiment of the present invention, each of the CQIs used in algorithm 400 indicate the quality of a single carrier and that a single UE will provide to the transmitter one CQI for each carrier on which it is capable of transmitting. Therefore, if there are N active UEs in the multi-carrier communications network and each UE can transmit on J carriers, then the transmitter will receive J*N CQIs (block 405). Note that there may not be a requirement that each UE makes use of the same number of carriers, however, this requirement will typically simplify implementation.

With J*N up-to-date channel quality indicators, the transmitter can select a number of CQIs, M, wherein M is greater than or equal to J but less than or equal to J*N (block 410). Note that M can vary each time that the transmitter performs transmission scheduling and its value is selected to maximize specified throughput to fairness criteria. Examples of specified throughput to fairness criterion can include maximum C/I (carrier to interference ratio), proportional fairness (instantaneous CQI normalized with average CQI), and any other criterion that trades off throughput maximization and fairness. For example, the transmitter may decide to select M CQIs because only these M CQIs have a C/I that exceeds a certain value. Note that there is but one fundamental restriction on M (J<=M<=J*N) and that M can be chosen each time the transmission scheduling is performed (once per transmission time interval, depending upon overall channel condition).

It may be possible that each active UE be assigned a set of carriers with a different number of carriers in each set. Let the number of carriers be denoted J₁, wherein J₁, is the number of carriers in the set of carriers for active UE I, and Jmin be the number of carriers in a set of carriers with a smallest number of carriers. In such a situation, then M may be selected so that it is greater than or equal to Jmin but less than or equal to a summation of J₁, over all active UEs in the multi-carrier communications system.

After selecting M, the transmitter can select K UEs based upon the value of M (block 415). The selection of the K UEs can be based on factors such as priority, connection priority, quality of service requirements, time since last service, size of transmission, size of transmission remaining, and so on. Note that the value of K can vary from one (when M=J and all J carriers are assigned to a single UE) to M (when each UE is assigned a single carrier). Once the transmitter has selected K UEs, the transmitter can determine transmission parameters for each of the K selected UEs (block 420).

The transmitter can determine the data transmission scheme to use on the carriers (for example, CDMA or OFDM), the modulation scheme (for example, QPSK, 16 QAM, 64 QAM, and so on), the packet size, the amount of error correcting data to include in the transmission, and so on. The modulation schemes and transmission parameters can be dependent upon the amount of data to be transmitted by a UE. For example, depending upon the amount of data to be transmitted, it is possible to have a situation wherein the data to be transmitted exceeds the amount of data that can be transmitted by a single carrier within a single transmit time interval, then it may be necessary to distribute the data across a plurality of carriers (with a maximum number of carriers being J). The sharing of the multiple carriers by the single UE can be accomplished by partitioning the data into multiple parts with each carrier transmitting a single part, multiplexing the data across the multiple carriers, or some combination of the above. Alternatively, there may not be enough data to consume a carrier's transmission bandwidth during the transmit time interval, then a single carrier can be used to transmit data from multiple UEs. With the modulation schemes and transmission parameters determined, the transmitter may finish with the scheduling of the transmissions of the K selected UEs (block 425).

It is possible to place certain additional constraints to the transmission scheduling, perhaps to limit control signal requirements, reduce UE complexity, reduce potential latency, service differentiation, and so forth. Examples of these additional constraints may include limiting a maximum number of carriers that can be assigned to a single UE to a value less than the maximum, fixing a maximum packet size to be equal for all UEs, allowing a maximum packet size to be different for each UE, imposing packet size or carrier restrictions if a retransmission is required, and so on.

Additionally, it can also be possible to place a limit on the frequency at which transmission scheduling or carrier assignments are made. For example, fast transmission scheduling/carrier assignment can be performed with CQIs that describe the current instantaneous channel condition, while slow transmission scheduling/carrier assignment can be performed with CQIs that describe the average channel condition over a longer period of time. Furthermore, fast transmission scheduling may be best performed at a base station (transmitter) that is actually performing the transmitting, slow transmission scheduling can be performed at either the base station or at a base station controller (BSC). A BSC is a part of a communications system that controls all base stations from within the communications system. It is also possible to perform slower transmission scheduling/carrier assignments at a radio network controller (RNC), which is connected to the BSC. An advantage of performing transmission scheduling/carrier assignments at the BSC or RNC is an ability to coordinate assignments within multiple transmission cells to minimize the effects of inter-cell interference. This however, comes at the expense of increased latency.

With reference now to FIG. 5, there is shown a diagram illustrating an algorithm 500 for use in scheduling transmissions in a multi-carrier communications system, wherein a single representative channel quality indicator is available from each UE, according to a preferred embodiment of the present invention. In the algorithm 400 (FIG. 4), each of the CQIs provided by the UEs represents a single carrier, therefore the algorithm 400 can get an accurate indicator of each carrier in the multi-carrier communications system. With the algorithm 500, each UE sends to the transmitter a single CQI. The CQI from a UE represents all of the carriers usable by the UE and can represent a maximum, an average, a minimum, or some other mathematically generated CQI for all of the carriers. As such, the transmitter may not have an accurate indicator of each and every carrier in the multi-carrier communications system. Therefore, the transmission scheduling performed by the transmitter can be done in a different fashion from the way transmission scheduling is performed in the algorithm 400. According to a preferred embodiment of the present invention, since a CQI represents all carriers of a single UE, the transmission scheduling is performed for all carriers usable by a UE.

With its up-to-date N CQIs (block 505), wherein N is a number of active UEs in the multi-carrier communications, the transmitter can select a number of CQIs, M, wherein M is greater than or equal to one (1) but less than or equal to N (block 510). As discussed previously, M can vary each time that the transmitter performs transmission scheduling and its value is selected to maximize specified throughput to fairness criteria. Examples of specified throughput to fairness criterion can include maximum C/I (carrier to interference ratio), proportional fairness (instantaneous CQI normalized with average CQI), and any other criterion that trades off throughput maximization and fairness.

After selecting M, the transmitter can select K UEs based upon the value of M (block 515). Note that since each CQI represents all carriers usable by a single UE, M will typically be equal to K since it is not possible to transmit to a single UE using more carriers than the number that is its set limit. If M is less than N, then the selection of the K UEs can be based on factors such as priority, connection priority, quality of service requirements, time since last service, size of transmission, size of transmission remaining, and so on. If M is equal to N, then each UE in the multi-carrier communications system can be selected, as long as there is data to transmit. The transmitter can now determine modulation schemes and transmission parameters for each of the K selected UEs (block 520), and when the modulation schemes and transmission parameters are determined, the transmissions can be scheduled (block 525). Again, each active UE can be assigned a set of carriers with a different number of carriers. In this situation, the selection of M can proceed in a manner similar to that discussed above.

Alternatives may exist when it comes to the scheduling of transmissions on a plurality of carriers. For example, rather than simply selecting a plurality of carriers based on carrier quality (via CQI), some carrier quality may be compromised to ensure that the carriers in a plurality of carriers that is assigned to a single UE are contiguous to each other in frequency to help ease UE (receiver) requirements. Additionally, scheduling can occur on both a downlink (base station to UE) and uplink (UE to base station). Downlink scheduling can occur where the base station receives the CQIs from the UEs and uses the CQIs to determine the UEs to transmit to (as described above), while uplink scheduling can occur where the base station measures channel quality from transmissions made by the UEs and provides specific permission to certain UEs to transmit.

With reference now to FIG. 6, there is shown a diagram illustrating a portion of a BS 600 of a multi-carrier communications system, wherein the BS 600 makes use of channel quality indicators to schedule and determine modulation-coding schemes for transmissions from the BS 600, according to a preferred embodiment of the present invention. The diagram of the BS 600 includes a portion that is responsible for taking a data stream and performing all necessary operations needed to transmit the data to its intended receiver(s). A packet formatter/scheduler 605 may be responsible for operations such as taking data from a data stream input and formatting it into proper transmission packets and then scheduling the transmission of the packets on the carriers of choice. Since the BS 600 may transmit to multiple UEs, the packet formatter/scheduler 605 may need to be capable of partitioning data based upon the different UEs as well as maintaining a transmission schedule for the different UEs. In addition to packet formatting and transmission scheduling, the packet formatter/scheduler 605 may also perform carrier(s) selection. For example, it may be specified that a packet be transmitted using two carriers. The packet formatter/scheduler 605 may then select the two carriers based on the carriers' CQI, for instance.

After packet formatting and scheduling, a modulator 610 can be used to apply the proper modulation needed to enable the transmission of the formatted packet using the selected carriers. Since it may be possible for the multiple carriers in a multi-carrier communications system to use different modulation techniques, the modulator 610 may need to be capable of applying the different modulation techniques to the formatted packets as needed. After modulation, a digital-to-analog converter (DAC) 615 can be used to convert the modulated signal into its analog representation and a mixer 620 can be used to bring the analog signal to proper frequencies for transmission purposes. A filter 625 can make sure that the analog signal fits within the frequency characteristic requirements of the carriers being used. Finally, the analog signal is provided to an antenna 630, which broadcasts the signal over-the-air.

A processor 635, such as a processing element, a general purpose processing unit, a custom designed processor, and so forth, can be used to control the operation of the BS 600 by executing control applications, special functions, and so on. If the packet formatter/scheduler 605 and the modulator 610 are designed to high-level functions, then when the BS 600 receives CQI values from the UEs, the processor 635 can provide the CQI values to the packet formatter/scheduler 605 and the modulator 610 to that the proper scheduling and selection carriers and modulation-coding schemes can be performed based on the CQI values. In such a situation, the processor 635 may not need to perform significant processing on the CQI values. However, if the packet formatter/scheduler 605 and the modulator 610 are designed to have minimal functionality, then the processor 635 may need to perform significant processing. For example, the processor 635 may need to maintain the CQI values for the various UEs, provide the CQI values for a UE whose transmissions are currently being formatted, scheduled, and modulated by the packet formatter/scheduler 605 and modulator 610 to the packet formatter/scheduler 605 and modulator 610, initiate new transmissions to update CQI values, and so on.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for scheduling transmissions in a multi-carrier communications system, the method comprising:
selecting a set of users from a group of users that are targets of intended transmissions, wherein the selection is based on channel quality information;
determining a set of transmission parameters for each user in the set of users; and
scheduling transmissions to the set of users.

2. The method of claim 1, wherein the channel quality information is provided by active users in the multi-carrier communications system.

3. The method of claim 2, wherein each active user in the multi-carrier communications system is assigned a set of carriers, wherein transmissions to the active user will occur on some or all of the carriers in the assigned set of carriers, and wherein the active user provides channel quality information for each carrier in the assigned set of carriers.

4. The method of claim 2, wherein each active user in the multi-carrier communications system is assigned a set of carriers, wherein transmissions to the active user will occur on some or all of the carriers in the assigned set of carriers, and wherein the active user provides channel quality information that is representative of all carriers in the assigned set of carriers.

5. The method of claim 4, wherein the channel quality information represents an average, a maximum, or a minimum channel quality value of all carriers in the assigned set of carriers.

6. The method of claim 2, wherein the channel quality information is periodically updated.

7. The method of claim 1, wherein the selecting is also based upon transmission requirements of intended transmissions to the users in the set of users.

8. The method of claim 7, wherein the transmission requirements include one or more of the following: overall transmission size, user priority, carrier priority, quality of service requirements, time since last service, size of transmission remaining unsent, time since transmission initiation.

9. The method of claim 1, wherein the selecting minimizes a throughput versus fairness criterion, and wherein the criterion is either maximize a carrier to interference ratio or proportional fairness.

10. The method of claim 1, wherein the transmission parameters include one or more of the following: data transmission scheme, modulation scheme, packet size, amount of error correcting data, number of carriers for a transmission, partitioning of a transmission across multiple carriers, placing multiple transmissions on a single carrier.

11. The method of claim 10, wherein a transmission made over multiple carriers can make use of a different data transmission scheme or a different modulation scheme on each carrier.

12. The method of claim 1, wherein each active user in the multi-carrier communications system is assigned a set of carriers, wherein the active user provides channel quality information for each carrier in the assigned set of carriers, and wherein the selecting comprises:
selecting M carriers based on a throughput versus fairness criterion, wherein M is a number between J and N*J inclusive, where J is a number of carriers in the set of carriers and N is a number of active users in the multi-carrier communications system; and
selecting the set of users based on the M carriers.

13. The method of claim 12, wherein a transmission to a user in the set of users can be assigned up to J carriers.

14. The method of claim 12, wherein each active user can be assigned a set of carriers with a different number of carriers, denoted J₁ where J₁ is a number of carriers in the set of carriers for active user I, and wherein M is a number between Jmin and a summation of J₁ over all active users inclusive.

15. The method of claim 1, wherein each active user in the multi-carrier communications system is assigned a set of carriers, wherein the active user provides channel quality information that is representative of all carriers in the assigned set of carriers, and wherein the selecting comprises:
selecting M carriers based on a throughput versus fairness criterion, wherein M is a number between 1 and N inclusive, where N is a number of users in the multi-carrier communications system; and
selecting the set of users based on the M carriers.

16. The method of claim 15, wherein a transmission to a user in the set of users is assigned J carriers, where J is a number of carriers in the set of carriers.

17. The method of claim 1, wherein the selecting, determining, and scheduling is performed at a base station, a base station controller, or a radio network controller.

18. A method for scheduling transmissions in a multi-carrier communications system, the method comprising:
transmitting a transmission to active users in the multi-carrier communications system, wherein the transmission occurs over a plurality of carriers, wherein the active users comprise every user in the multi-carrier communications system;
receiving channel quality information from each active user; and
scheduling future transmissions to a user using the channel quality information provided by the active users.

19. The method of claim 18, wherein the transmission to active users is a data transmission, a control transmission, a specially encoded transmission, or a dedicated feedback channel transmission.

20. The method of claim 18, wherein the scheduling comprises:
selecting a set of users from a group of users which are targets of intended transmissions, wherein the selection is based on channel quality information;
determining a set of transmission parameters for each user in the set of users; and
scheduling transmissions to the set of users.

21. The method of claim 18, wherein each active user provides a plurality of channel quality information, with one channel quality information for each carrier in the plurality of carriers.

22. The method of claim 18, wherein each active user provides channel quality information, and wherein the channel quality information represents a minimum, an average, or a maximum channel quality in the plurality of carriers.

23. The method of claim 18, wherein the channel quality information provided by each active user is changeable depending upon the transmission methodology of the transmitting of the transmission.

24. The method of claim 18, wherein the multi-carrier communications system has a carrier that is used to provide compatibility with legacy communications systems, and wherein all channel quality information is received via the carrier.

25. The method of claim 18, wherein the receiving is done over a feedback control channel.
